(19) United States
(12) Patent Application Publication
(10) Pub. No.: US 2013/0047009 A1
(43) Pub. Date: Feb. 21, 2013

(54) COMPUTING DEVICE, STORAGE MEDIUM AND METHOD FOR TESTING STABILITY OF SERVER

(71) Applicants: MING LI, Shenzhen City (CN); SHAN-LI YANG, Shenzhen City (CN)

(72) Inventors: MING LI, Shenzhen City (CN); SHAN-LI YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/442,043

(22) Filed: Apr. 9, 2012

(30) Foreign Application Priority Data
Aug. 15, 2011 (CN) 201110232872.7

(51) Int. Cl. G06F 1/00

(52) U.S. Cl. 713/310

(57) ABSTRACT

In a method for testing stability of a server using a computing device, a power act that is executed by the server and a number of times for executing the predetermined power act are predetermined. The computing device periodically sends a control command to a baseboard management controller (BMC) of the server for controlling the server to execute the predetermined power act, and counts a number of times the server executes the predetermined power act. The computing device determines that the server stably executes the predetermined power act if the counted number of times reaches the predetermined number of times, or determines that the server does not stably execute the predetermined power act if the counted number of times does not reach the predetermined number of times.

### BACKGROUND

1. Technical Field

Embodiments of the present disclosure relate to server testing, and more particularly to a computing device, a storage medium and a method for testing stability of a server.

2. Description of Related Art

After a server is assembled, manufacturers need to test the stability of the server. A known stability testing method of the server refers to testing whether the server can periodically and stably execute a single power act, such as power cycling. However, the method cannot test the stability of the server when the server periodically executes various power acts, such as power cycling, power on-off, and soft reboot. What is needed, therefore, is an improved method for testing the stability of a server to overcome the limitations described.

### BRIEF DESCRIPTION OF THE DRAWINGS

FIG. 1 is a block diagram of one embodiment of a computing device including a stability test system.

FIG. 2 is a block diagram of one embodiment of functional modules of the stability test system included in the computing device of FIG. 1.

FIG. 3 is a flowchart of one embodiment of a method for testing stability of a server using the computing device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

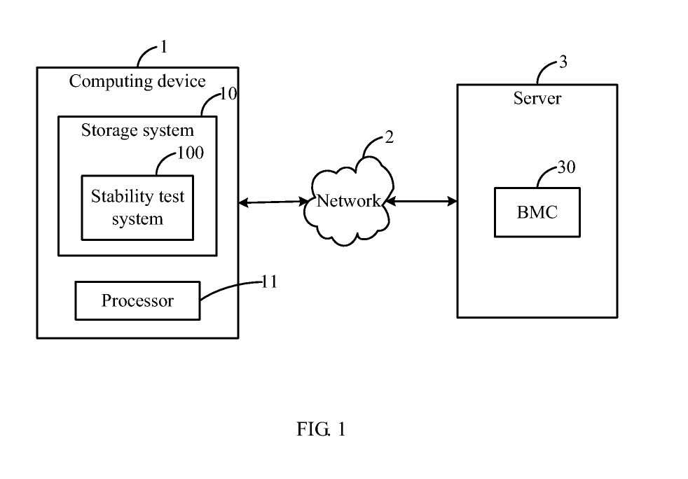

FIG. 1 is a block diagram of one embodiment of a computing device 1 including a stability test system 100, which is used for testing stability of a server 3. In the embodiment, the computing device 1 further includes a storage system 10 and at least one processor 11. The computing device 1 communicates with the server 3 via a network 2, such as a wide area network or the Internet. The server 3 includes a baseboard management controller (BMC) 30. FIG. 1 is just one example of the computing device 1 that can be included with more or fewer components than shown in other embodiments, or have a different configuration of the various components.

The stability test system 100 may be in form of one or more programs that are stored in the storage system 10 and executed by the at least one processor 11. The stability test system 100 sends control commands, such as intelligent platform management interface control commands, to the BMC 30 for controlling the server 3 to execute power acts, and determine stability of the server 3. In the embodiment, the power acts may include power on-off, power cycling, or soft reboot.

The power on-off is defined as an act of turning the server 3 off when the BMC 30 receives a power-off command from the computing device 1, or turning the server 3 on when the BMC 30 receives a power-on command from the computing device 1. The process of turning off the server 3 or turning on the server 3 may respectively take thirty to fifty seconds.

The power cycling is defined as an act of turning the server 3 off and then turning the server 3 on again when the BMC 30 receives a power cycling command from the computing device 1. The process of turning off and turning on the server 3 may take thirty to fifty seconds.

The soft reboot is defined as an act of restarting the server 3 without removing power or triggering a hardware-based reset when the BMC 30 receives a rebooting command from the computing device 1. The process of soft reboot of the server 3 may take ten to forty seconds.

In one embodiment, the storage system 10 may be a random access memory (RAM) for temporary storage of information, and/or a read only memory (ROM) for permanent storage of information. In other embodiments, the storage system 10 may also be an external storage device, such as a hard disk, a storage card, or a data storage medium. The at least one processor 11 executes computerized operations of the computing device 1 and other applications, to provide functions of the computing device 1.

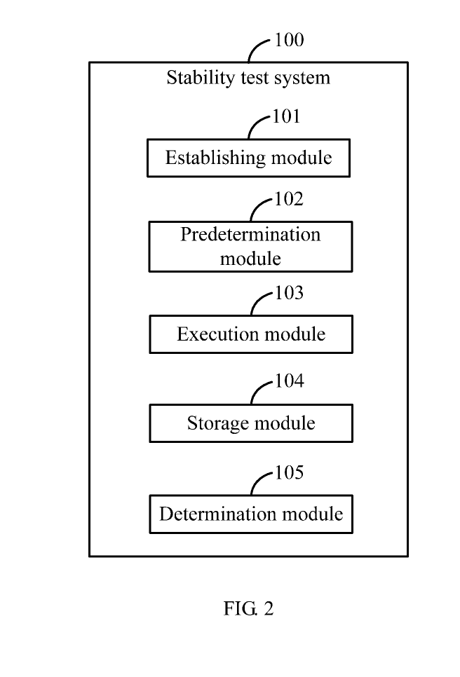

FIG. 2 is a block diagram of functional modules of the stability test system 100 included in the computing device 1 of FIG. 1. In one embodiment, the stability test system 100 may include an establishing module 101, a predetermination module 102, an execution module 103, a storage module 104, and a determination module 105. The modules 101-105 may comprise a plurality of functional modules each comprising one or more programs or computerized codes that are stored in the storage system 10 and executed by the at least one processor 11. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The establishing module 101 establishes communication between the computing device 1 and the server 3 according to an IP address of the BMC 30. In one embodiment, the IP address may be defined as “101.250.156.122”, for example.

The predetermination module 102 predetermines a power act that is executed by the server 3. In one embodiment, the predetermined power act may be one of the power on-off, the power cycling or the soft reboot. The one of the power on-off, the power cycling or the soft reboot can be determined randomly or by the user. In one example, the predetermination module 102 can select a random number, and acquire a remainder of division of the random number by three. If the remainder is “0”, the predetermined power act is the power on-off. If the remainder is “1”, the predetermined power act is the power cycling. If the remainder is “2”, the predetermined power act is the soft reboot.

In another embodiment, the predetermined power act may be a combination of two or three of the power on-off, the power cycling and the soft reboot. For example, the predetermined power act is a combination of the power cycling and the soft reboot, and the power cycling is executed first, then the soft reboot.

The predetermination module 102 further predetermines a time period and a number of times for executing the predetermined power act, and a file that is stored in the storage system 10. For example, the predetermined time period may be fifty seconds, and the predetermined number of times may be one hundred.

The execution module 103 periodically sends a control command to the BMC 30 for controlling the server 3 to execute the predetermined power act according to the predetermined time period. In the embodiment, the control command may be a power-on command, a power-off command, a power cycling command, or a rebooting command. For example, if the predetermined power act is the power on-off that is determined by the user, the execution module 103 sends the power-on command to the BMC 30 for turning off the server 3, and after the predetermined time period, the execution module 103 sends the power-off command to the BMC 30 for turning on the server 3.

The storage module 104 stores a sending time of the control command and a return value received from the server 3 in the predetermined file of the storage system 10 at each time of sending the control command to the BMC 30. The return value indicates whether the server 3 successfully executes the predetermined power act according to the control command. For example, the return value “1” indicates the server 3 successfully executes the predetermined power act. The return value “0” indicates the server 3 fails to execute the predetermined power act.

The execution module 103 further controls a counter to count a number of times the server 3 executes the predetermined power act. For example, if the server 3 has executed the predetermined power act for three times so far, the counted number of times is three.

The determination module 105 determines whether the counted number of times reaches the predetermined number of times when the server 3 fails to execute the predetermined power act according to the control command. If the counted number of times reaches the predetermined number of times, the determination module 105 determines that the server 3 stably executes the predetermined power act. If the counted number of times does not reach the predetermined number of times, the determination module 105 determines that the server 3 does not stably execute the predetermined power act.

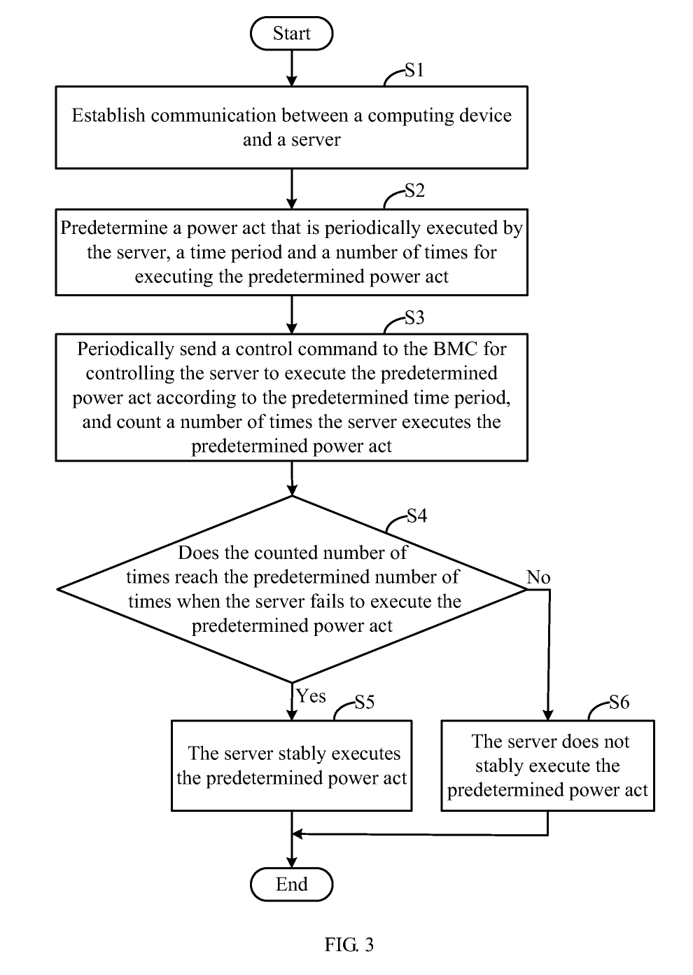

FIG. 3 is a flowchart of one embodiment of a method for testing stability of the server 3 using the computing device 1 of FIG. 1. Depending on the embodiment, additional steps may be added, others removed, and the ordering of the steps may be changed.

In step S1, the establishing module 101 establishes communication between the computing device 1 and the server 3 according to an IP address of the BMC 30, such as “101.250.156.122”, for example.

In step S2, the predetermination module 102 predetermines a power act that is executed by the server 3, a time period and a number of times for executing the predetermined power act, and a file that is stored in the storage system 10. In one embodiment, the predetermined power act may be one of the power on-off, the power cycling or the soft reboot that is determined randomly or by the user. In another embodiment, the predetermined power act may be a combination of two or three of the power on-off, the power cycling and the soft reboot.

In step S3, the execution module 103 periodically sends a control command to the BMC 30 for controlling the server 3 to execute the predetermined power act according to the predetermined time period. In the embodiment, the control command may be a power-on command, a power-off command, a power cycling command, or a rebooting command. The storage module 104 stores a sending time of the control command and a return value received from the server 3 in the predetermined file at each time of sending the control command to the BMC 30. The return value indicates whether the server 3 successfully executes the predetermined power act according to the control command. The execution module 103 further controls a counter to count a number of times the server 3 executes the predetermined power act.

In step S4, the determination module 105 determines whether the counted number of times reaches the predetermined number of times when the server 3 fails to execute the predetermined power act according to the control command. If the counted number of times reaches the predetermined number of times, step S5 is implemented. If the counted number of times does not reach the predetermined number of times, step S6 is implemented.

In step S5, the determination module 105 determines that the server 3 stably executes the predetermined power act.

In step S6, the determination module 105 determines that the server 3 does not stably execute the predetermined power act.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage system;
at least one processor; and
one or more programs stored in the storage system and executed by the at least one processor, the one or more programs comprising:
a predetermination module that predetermines a power act that is executed by a server, and a number of times for executing the predetermined power act;
an execution module that periodically sends a control command to a baseboard management controller (BMC) of the server for controlling the server to execute the predetermined power act, and counts a number of times the server executes the predetermined power act; and
a determination module that determines that the server stably executes the predetermined power act if the counted number of times reaches the predetermined number of times, or determines that the server does not stably execute the predetermined power act if the counted number of times does not reach the predetermined number of times.

2. The computing device of claim 1, further comprising:
an establishing module that establishes communication between the computing device and the server according to an IP address of the BMC.

3. The computing device of claim 1, wherein the predetermined power act is one of power on-off, power cycling or soft reboot, or is a combination of two or three of the power on-off, the power cycling and the soft reboot.

4. The computing device of claim 1, wherein the predetermination module further predetermines a time period for executing the predetermined power act, and a file that is stored in the storage system.

5. The computing device of claim 4, wherein the execution module periodically sends a control command to the BMC according to the predetermined time period, and the control command is a power-on command, a power-off command, a power cycling command, or a rebooting command.

6. The computing device of claim 5, further comprising:
a storage module that stores a sending time of the control command and a return value received from the server in the predetermined file at each time of sending the control command to the BMC, wherein the return value indicates whether the server successfully executes the predetermined power act.

7. A method for testing stability of a server using a computing device, the method comprising:
(a) predetermining a power act that is executed by the server, and a number of times for executing the predetermined power act;
(b) periodically sending a control command to a baseboard management controller (BMC) of the server for controlling the server to execute the predetermined power act, and counting a number of times the server executes the predetermined power act; and
(c) determining that the server stably executes the predetermined power act if the counted number of times reaches the predetermined number of times; or
(d) determining that the server does not stably execute the predetermined power act if the counted number of times does not reach the predetermined number of times.

8. The method of claim 7, further comprising:
establishing communication between the computing device and the server according to an IP address of the BMC.

9. The method of claim 7, wherein the predetermined power act is one of power on-off, power cycling or soft reboot, or is a combination of two or three of the power on-off, the power cycling and the soft reboot.

10. The method of claim 7, wherein the step (a) further comprises:
predetermining a time period for executing the predetermined power act, and a file that is stored in the storage system.

11. The method of claim 10, wherein the step (b) further comprises:
periodically sending a control command to the BMC according to the predetermined time period, wherein the control command is a power-on command, a power-off command, a power cycling command, or a rebooting command.

12. The method of claim 11, further comprising:
storing a sending time of the control command and a return value received from the server in the predetermined file at each time of sending the control command to the BMC, wherein the return value indicates whether the server successfully executes the predetermined power act.

13. A non-transitory storage medium storing a set of instructions, the set of instructions capable of being executed by a processor of a computing device, causes the computing device to execute a method for testing stability of a server, the method comprising:
(a) predetermining a power act that is executed by the server and a number of times for executing the predetermined power act;
(b) periodically sending a control command to a baseboard management controller (BMC) of the server for controlling the server to execute the predetermined power act, and counting a number of times the server executes the predetermined power act; and
(c) determining that the server stably executes the predetermined power act if the counted number of times reaches the predetermined number of times; or
(d) determining that the server does not stably execute the predetermined power act if the counted number of times does not reach the predetermined number of times.

14. The storage medium of claim 13, wherein the method further comprises:
establishing communication between the computing device and the server according to an IP address of the BMC.

15. The storage medium of claim 13, wherein the predetermined power act is one of power on-off, power cycling or soft reboot, or is a combination of two or three of the power on-off, the power cycling and the soft reboot.

16. The storage medium of claim 13, wherein the step (a) further comprises:
predetermining a time period for executing the predetermined power act, and a file that is stored in the storage system.

17. The storage medium of claim 16, wherein the step (b) further comprises:
periodically sending a control command to the BMC according to the predetermined time period, wherein the control command is a power-on command, a power-off command, a power cycling command, or a rebooting command.

18. The storage medium of claim 17, wherein the method further comprises:
storing a sending time of the control command and a return value received from the server in the predetermined file at each time of sending the control command to the BMC, wherein the return value indicates whether the server successfully executes the predetermined power act.
